(19) United States
(12) Patent Application Publication
(10) Pub. No.: US 2010/0070410 A9
(43) Pub. Date: Mar. 18, 2010

(54) Method and apparatus for value and or revenue sharing by commerce participants

(76) Inventor: Johann Verheem, San Clemente, CA (US)

Correspondence Address: THE NATH LAW GROUP, 112 South West Street, Alexandria, VA, 22314, US

(21) Appl. No.: 11/716,155

(22) Filed: Mar. 8, 2007

Related U.S. Application Data
(60) Provisional application No. 60/902,800, filed on Feb. 21, 2007.

(51) Int. Cl. G06Q 40/00

(52) U.S. Cl. 705/40

(57) ABSTRACT

A method whereby the relative contribution of value added to e-commerce sites by users such as contributors, browsers, buyers and sellers are measured and weighed while these users are vesting in a prorated share of either or both the revenue and asset value created by their participation, less the portion kept by the company or provider. Each user's contribution is vested instantly, dynamically and objectively by measuring relative revenue or web traffic that results from their participation.

### RELATED APPLICATIONS

This application claims priority to copending U.S. Provisional Patent Application 60/______ filed Feb. 21, 2007 with attorney docket number 212/989.

### FIELD OF THE INVENTIONS

The inventions described below relate to the field of commerce and more specifically to methods and apparatus for sharing value and or revenue of a commercial endeavor such as an electronic commerce site by users and participants.

### BACKGROUND OF THE INVENTIONS

Conventional commercial models are undergoing changes due to the broad acceptance of the internet and its use to generate revenue. Recent acquisitions of internet sites, or e-commerce sites such as “YouTube” have demonstrated the value of user provided content. However, the users (the viewers and the providers of the content) have no opportunity to share in the value and possible revenue generated by the content created and or provided by users.

What is needed is a new business method and apparatus for value and revenue sharing by e-commerce participants.

### SUMMARY

An internet website may permit contributors of content to participate in value of the website, and or revenue generated by the website. The contribution of the content to the value of a website may be dynamically and objectively determined by any suitable method. For example popularity of the content may be the determining factor, or popularity among a particular population segment, or number of visits a piece of content generates, or the average time a piece of content is visible to browsers may be suitable measures of value.

An internet website or other commercial endeavor may generate revenue from either advertisers, collecting membership dues, subscription fees from visitors, revenue sharing based click through, revenue based on products sold or any other suitable technique. Some or all contributors may receive a portion of the revenue as determined by the relative value to the website of the content provided by the contributor. The value of a piece of content or all the content from a single contributor may be expressed as a percentage of the revenue stream as determined by the popularity of the content.

Content may include advertising, still photographs, video, text, music, games, real products or any suitable combination of content elements.

A method whereby the relative contribution of value added to e-commerce sites by users such as contributors, browsers, buyers and sellers are measured and weighed while these users are vesting in a prorated share of either or both the revenue and asset value created by their participation, less the portion kept by the company or provider. Each user's contribution is vested instantly, dynamically and objectively by measuring relative revenue or web traffic that results from their participation.

A method of valuing contributions of a user browsing an e-commerce of other network site, page, or element includes valuing the e-commerce site using a purchase offer or completed sale or a revenue stream, identifying a portion of the value that will be reserved to the founders, operators and or shareholders of the site, subtracting the reserved value from the total value to identify a contributors value of the site, calculating a users contribution of the user to the contributors value of the site, and providing the user with the value of his or her contribution as currency, credit, goods and or services or other medium of exchange mutually acceptable to the user and the e-commerce site. For example, a person such as user A, may establish a website and provide one or more links to the website from a participating e-commerce site. The number of browsers directed to user A's website through the e-commerce site may be used to determine the value of user A to the e-commerce site. User A may receive any suitable economic interest as compensation for their contribution.

Contributors and participants of any commercial endeavor may participate in the value of the commercial endeavor by having their contributions dynamically and objectively determined. Thus a brick & mortar business may compensate visitors and or purchasers according to the relative contribution of each to the value of the business as determined objectively using any suitable technique.

### BRIEF DESCRIPTION OF THE DRAWINGS

FIG. 1 is a block diagram of a network including an e-commerce system.

FIG. 2 is a block diagram of the process of valuing the contribution of a contributor to a website.

### DETAILED DESCRIPTION OF THE INVENTIONS

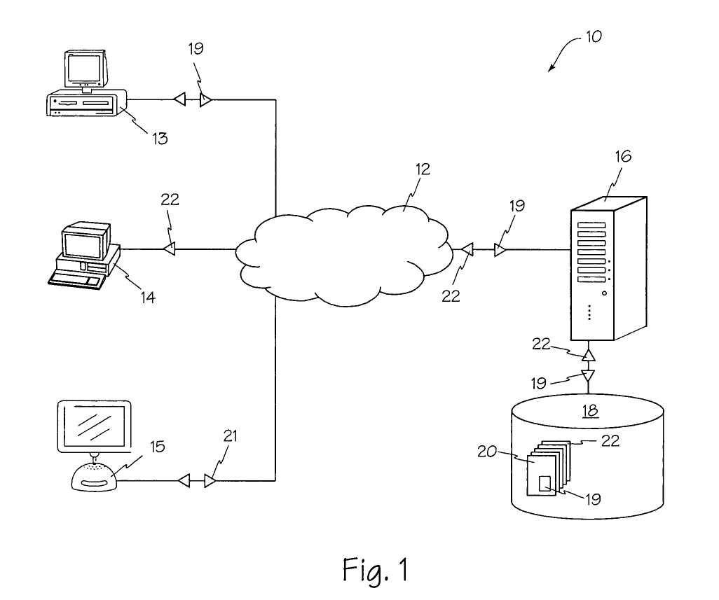

e-Commerce system 10 of FIG. 1 includes network 12 connecting multiple users on distributed computers such as computers 13, 14 and 15 along with network servers such as server 16. Server 16 may also include internal storage or external storage such as storage 18. A user such as the user on computer 13 may create or otherwise make available one or more pieces of content such as file 19 that may be transmitted through network 12 to a server such as server 16 for storage and inclusion on one or more pages of content such as page 20.

If a website operating according to the disclosed method logs 100,000 visits, or hits per month and a user such as subscriber 1 from computer 15 has created or otherwise provided content 21 which is responsible for generating 10,000 unique visits, hits, or visitors as determined by the company, subscriber 1 from computer 15 would be entitled to 10% of the total percentage of profit the company designates to the subscribers, whether such profit is from revenues or proceeds of a sale.

Similarly a customer loyalty program may be used that is tied to the user browsing specific websites or other sites on any suitable network such as the internet. A user such as the user of computer 14 may earn points by browsing selected websites or pages such as page 22 and may earn additional points by purchasing products and or services.

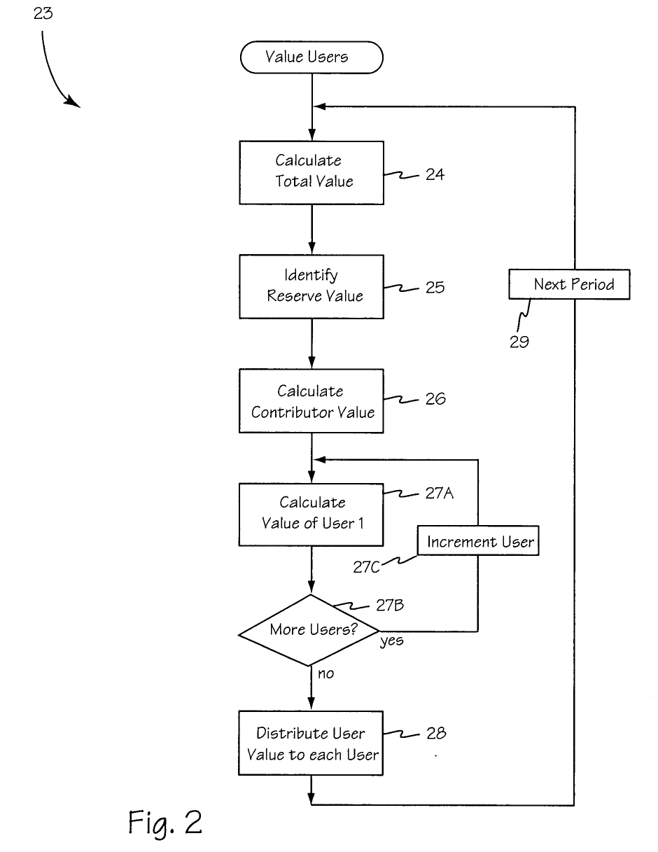

Referring now to FIG. 2, method 23 of valuing contributions of a user contributing or browsing an e-commerce or other network site, page, or element includes valuing the e-commerce site at step 24, using a purchase offer or completed sale or a revenue stream. Identifying a portion of the value that will be reserved to the founders, operators and or shareholders of the site at step 25. Subtracting the reserved value from the total value to identify a contributors value of the site at step 26. Calculating each users contribution to the contributors value of the site at steps 27A, 27B and 27C. Distributing to each user with the value of his or her contribution as currency, credit, goods and or services or other medium of exchange mutually acceptable to the user and the e-commerce site as shown in step 28. This method may be applied once upon sale of a website, or periodically based on a revenue stream. If user value is calculated periodically, step 29 the process repeats at step 24 for each period.

A meter or other suitable indicator of a participant's contribution to a website's value may also be available through the user's browser. The value indicator may be updated based on the calculation period determined above. The value added and thus tracked by the value indicator may be calculated using any suitable metric or combinations of metrics. Similarly, for brick and mortar commercial endeavors a participant, a shopper or a purchaser may be similarly rewarded.

A user may be identified by either a cookie, an IP address or a computer ID from which transactions are being initiated and from which the internet is being searched or by logging into an identification service created specifically for using the loyalty program.

Points may be earned and may be converted into money, merchandise, services or may be applied to reduce or eliminate interest payable for a credit card or any other suitable incentive. By browsing enough the user may be earning cash back on purchases and may be paying no interest on participating credit cards.

The value of the rewards may be derived from advertising revenue on the websites visited as well as affiliate click-through programs. Users may use any participating credit card or they may also be able to apply for a credit card through participating partners.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

I claim:

1. A method of valuing contributions of a user contributing or browsing an e-commerce of other network site, page, or element comprising the steps:
calculating a total value of an e-commerce site;
identifying a portion of the total value that will be reserved to the founders, operators and or shareholders of the e-commerce site;
calculate the contributor's value of the site by subtracting the reserved value from the total value;
calculating a user's contribution to the contributors value of the site; and
providing the user with the value of his or her contribution in a medium of exchange mutually acceptable to the user and the e-commerce site.

2. The method of claim 1 wherein total value is determined using a purchase offer.

3. The method of claim 1 wherein total value is determined using a completed sale of the e-commerce site.

4. The method of claim 1 wherein total value is determined using a revenue stream.

5. The method of claim 1 wherein the medium of exchange is currency.

6. The method of claim 1 wherein the medium of exchange is credit.

7. The method of claim 1 wherein the medium of exchange is products.

8. The method of claim 1 wherein the medium of exchange is services.
